(19) United States
(12) Patent Application Publication
(10) Pub. No.: US 2007/0262875 A1
(43) Pub. Date: Nov. 15, 2007

(54) RF tag for a mechanical component

(76) Inventor: Yehia M. El-Ibiary, Simpsonville, SC (US)

Correspondence Address: THOMPSON COBURN, LLP, ONE US BANK PLAZA, SUITE 3500, ST LOUIS, MO, 63101, US

(21) Appl. No.: 11/433,654

(22) Filed: May 12, 2006

(51) Int. Cl. G08B 13/14

(52) U.S. Cl. 340/572.8

(57) ABSTRACT

An RFID tagging device is disclosed for metallic mechanical components. The device includes a support made of a non-metallic material. The support supports an RFID tag, such as a passive tag that may be applied to support as a decal or otherwise. The device may be secured to a mechanical component by any suitable fastener that may extend through a hole provided in the support. The support then holds the tag a sufficient distance from the component so that the metallic component itself does not interfere with the receipt or transmission of signals from the tag via the tag antenna.

### BACKGROUND

The present invention relates generally to the field of mechanical power transmission components and to systems for maintaining data relating to installed equipment of such systems. More particularly, the invention relates to a radio frequency tagging and identification system for use in conjunction with metallic power transmission components.

The field of power transmission systems is well-established and developed. In general, such systems include a wide range of rotating and non-rotating equipment, typically including motors and other prime movers that drive loads, such as pumps, conveyers, gearing, and so forth. A wide range of applications in industry exist for such power transmission systems. Highly integrated components and systems of this type are typically found in all modern factories, production facilities, materials handling facilities, and power plants, to mention but a few settings.

A continuing difficulty in power transmission system management and servicing stems from a lack of knowledge of exactly what components are installed, and a lack of information regarding models, sizes, manufacturing histories, maintenance histories, and so forth for each component. When power transmission systems are installed, for example, “as built” drawings and documentation may be produced and delivered with the original equipment. However, over time changes are made to equipment, additional equipment is added, equipment is removed, and components are replaced typically making such “as built” documentation of little or no use.

While more sophisticated equipment that includes embedded memory, micro-processors, and the like can be made “intelligent” so as to recall their identification, or even to store their manufacturing and service data, many components simply are not equipped for this type of intelligence. For example, electric motors, bearings, pumps, pulleys, gear reducers, and so forth do not typically include electronics which are capable of storing this type of information. Accordingly, these components are essentially untraced in current installations, except perhaps by name plates that must be manually read, if present and accessible.

The field of asset management has developed in the direction of tagging certain components, such as with radio frequency identification (RFID) tags. Several standards exist for RFID tags in current technology, particularly relating to the storage and access to information, frequencies of response of tags and readers, and so forth. In general, RFID tags may be divided into two primary classifications, active and passive. Active tags may require a power source, but may store certain information that can be accessed directly by a reader. Passive tags generally are unpowered, but can respond to fields or signals from a reader to return a minimum amount of information stored in the tag. While active tags generally provide more information, they are substantially more expensive at present than passive tags, and as such are cost prohibitive for many applications. Moreover, all RFID tags suffer from the need to transmit and receive signals by means of an attached antenna. The metallic housings and structures of power transmission components attenuate both received and transmitted signals such that this technology has heretofore been virtually unusable in such systems and with such components.

There is a need, therefore, for an improved technique that would allow tagging and tracking of information for mechanical power transmission components. There is a particular need for a simple, cost effective solution that would allow conventional RF tags to be associated with metallic power transmission components so as to employ more powerful database and data storage capabilities of external computer systems.

### BRIEF DESCRIPTION

The invention provides a novel RFID tagging approach designed to respond to such needs. The system may be used with a wide range of mechanical components, but is particularly designed for use with metallic components to which RFID tags cannot otherwise be attached due to the attenuation of signals to or from their antennae. Such power transmission components may include, for example, bearings, motors, gear reducers, pulleys, mechanical mounts, pumps, and so forth. More generally, however, the tagging system may be used with other mechanical components that would attenuate RFID signals, such as valves, manifolds, actuators, and so forth.

In accordance with aspects of the invention, radio frequency tagging device is provided for metallic mechanical components. The tagging device includes a non-metallic support that has an aperture formed therethrough. The aperture serves to receive a fastener to secure the tag to the mechanical component. The device also includes an RF tag that is supported on the support. The RF tag encodes at least identification information for the mechanical component to which the device is secured. Various types of fasteners may be used to secure the support and tag to the mechanical component. These might include bolts, screws, rivets, as well as other fastening devices, such as grease fittings, piping, and so forth.

In accordance with a particular aspect of the invention, the support has a toroidal configuration. The support is made of a synthetic plastic material and the toroid surrounds an aperture designed to receive a fastener that is used to secure the tag to the mechanical component. An adhesively-backed RF tag is wrapped around the plastic toroidal support and encodes at least identification information for the mechanical component.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a exemplary mechanical component, in the form of a bearing assembly, on which an RFID tagging device has been secured in accordance with aspects of the invention;

FIG. 2 is an exploded view of an exemplary RFID tagging device in accordance with the invention illustrated with several different types of fasteners that may be used to secure the device to a mechanical component;

FIG. 3 is a diagrammatical illustration of a bobbin or toroidal-shaped support and a series of RFID tags that can be adhesively secured to the support in accordance with aspects of the invention; and

FIG. 4 is a diagrammatical overview of a mechanical system in which a series of RFID tagging devices are associated with mechanical components and are detectable by a reader system for evaluation of the identification of the components and for accessing related manufacturing, maintenance, and other data.

### DETAILED DESCRIPTION

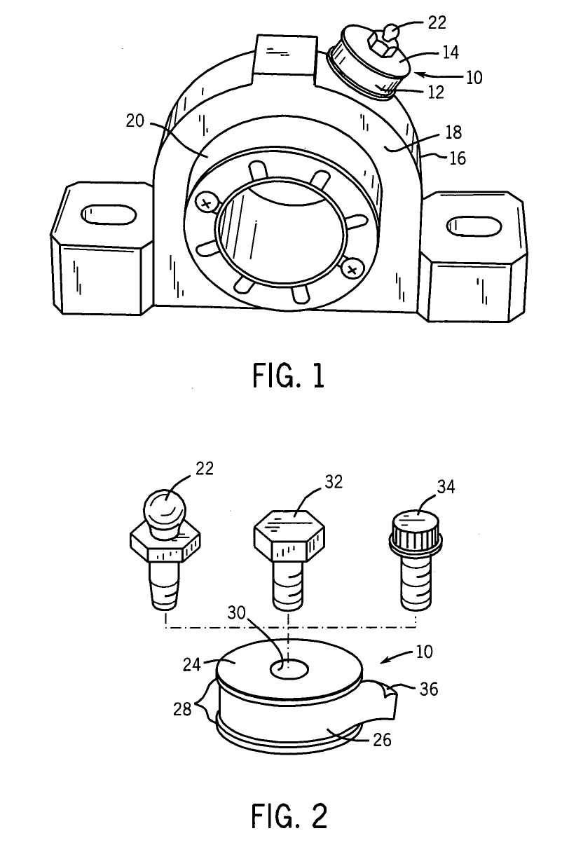

Turning now to the drawings, and referring first to FIG. 1, an RFID tagging device 10 is illustrated as secured to a metallic mechanical component in accordance with aspects of the invention. In the illustrated embodiment, the RFID tagging device 10 includes a tag 12 secured to a carrier or support 14. The support 14 both holds and protects the tag 12 and maintains it a distance from surrounding metallic surfaces sufficient to prevent significant attenuation of the radio frequency signals emitted to the tag and received from the tag during reading operations, as described in greater detail below. The device 10 may be secured to any range of metallic mechanical components. The device is particularly well-suited to components that do not include their own devoted memory or processing capabilities that could otherwise store significant volumes of data. In the illustrated embodiment, for example, the mechanical component is a bearing assembly 16. As will be appreciated by those skilled in the art of power transmission systems, the assembly shown in FIG. 1 includes a pillow block housing 18 in which a bearing 20 is fitted.

The RFID tagging device 10 is designed to be secured to the metallic mechanical component by means of a fastener or other device that extends through the support 14 as described in greater detail below. It should be noted that any range of fastening devices may be employed for this purpose. For example, in the illustration of FIG. 1, a grease fitting 22 that supplies lubricant to an internal volume of the bearing assembly is used to mount the tagging device to the bearing housing. FIG. 2 illustrates additional possibilities for fasteners used to secure the RF tagging device to a metallic mechanical component.

Referring to FIG. 2, in a present embodiment the tagging device 10 includes the support which comprises a body 24 that may take the general form of a bobbin or disk. The body 24 may be made of any suitable material, but is preferably made of a non-metallic material, such as molded synthetic plastic. The body has a central surface 26 around its outer parameter that is bounded by flanges or lips 28. It has been found that the central surface 26 serves as a convenient support for the RFID tag, as described below, while the flanges 28 aid in protecting the tag in service. Other configurations for the mount, of course, may be envisaged. The cylindrical or disk-like arrangement of the illustrated embodiment may be preferable due to its simplicity and the ability to wrap an RFID tag around the central surface 26 without sharp corners that could otherwise result in delamination of the tag from the support.

As also illustrated in FIG. 2, the body 24 has a central aperture 30 formed therethrough. The aperture extends completely through the body from one side to the other and serves to receive the fastener used to secure the device to the metallic component. As noted above, a number of different fasteners may be employed, such as, by way of example only, fittings 22, bolts 32, screws 34, and so forth. In general, where molded plastic material is used for the support, it may generally be advisable to avoid excessive loading on the support as the fastener is installed, that could otherwise damage the support. Thus, non-loaded fasteners would likely be the preferred arrangements for mounting the RFID tagging device in an application.

The RFID tag itself is preferably a passive tag due to the substantial cost savings of such tags as opposed to active tags. The tag may be mounted to the support in any suitable manner, and in a present embodiment the tag is mounted by means of an adhesive backing 36 illustrated generally in FIG. 2. The illustration of FIG. 2 shows the tag partially peeled from the central surface 26 to illustrate the manner in which it is wrapped around the central surface 26 during application, and to illustrate its adhesive backing surface 36. Alternatively, where appropriate, the tag may be embedded in the support or covered by a protective layer (not shown) such as tape, paint or varnish.

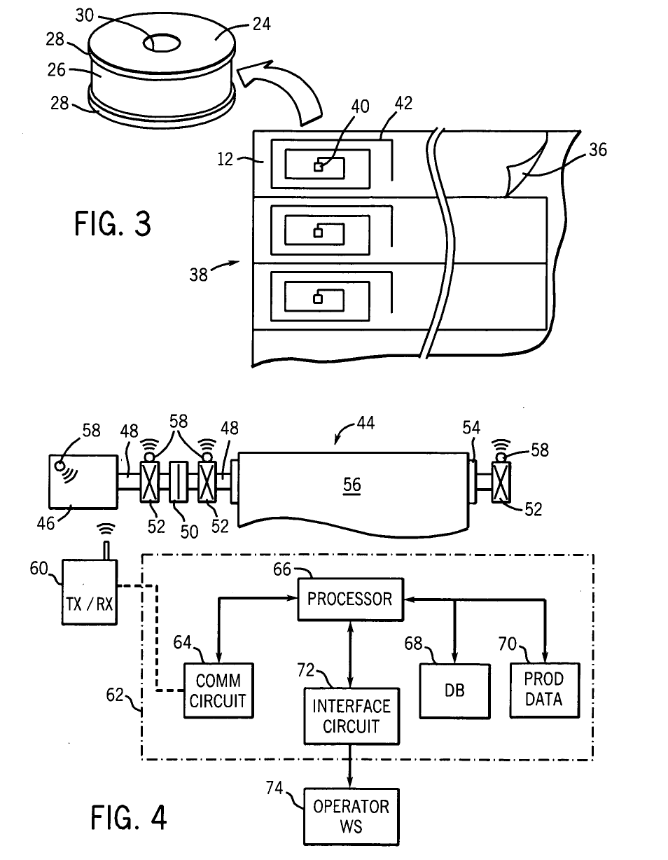

FIG. 3 generally illustrates a present technique for producing the tags shown in FIGS. 1 and 2. As will be appreciated by those skilled in the art, the RFID tags themselves may be available as preassembled decals 38 which each include an RFID chip 40 coupled to an antenna 42. One chip and one antenna are typically provided on each preassembled decal 38. The decals 38 may be peeled from a support on which they are delivered to expose their adhesive backing 36. The decal is then wrapped around the RFID tag support, the central surface 26 of which is exposed as illustrated in FIG. 3.

The support is dimensioned and configured not only to hold and protect the tag during use, but to maintain the tag a sufficient distance from surrounding metal, such that the metal does not interfere with signals to and from the tag (i.e., does not cause attenuation of the signal that interferes with reading of the tag). In a present embodiment, the support has a height of ½ inch and a diameter of approximately 1¼ inches. The adhesive tags have dimensions of approximately ⅜ inch by 4 inches. When applied to the non-metallic support, then, the tag is spaced from any surrounding metallic surface such that signals can be received by the antenna and returned from the antenna by excitation by an RFID reader. In a present embodiment, the tag, and particularly its antenna, is spaced at least ⅛ inch from any surrounding metal that might attenuate the RF signals. Moreover, it should be noted that any suitable tag may be employed, such as tags operating at conventional frequencies, such as 13.56 MHz, 915 MHz, or 2.4 GHz. It should be noted that in some embodiments, the surface on which the tag is mounted may be otherwise configured, such as be elongating the surface to permit the use of tags having more extensive antennae (i.e., tags that are spirally wrapped around the support or physically larger tags).

FIG. 4 illustrates an exemplary application for the RFID tagging devices described above. In the illustration of FIG. 4, a machine system 44 includes a series of mechanical components, such as a motor 46, shafting 48, a coupling 50, bearings 52, a pulley 54, and a conveyer belt 56. As will be appreciated by those skilled in the art, a simple conveyer system of the type illustrated in FIG. 4 will typically employ motor 46 to drive the shafting 48, that is coupled to the pulley 54. Bearings 52 support the shafting during operation, and absorb loading of the motor and the conveyer. It should be noted that the machine system illustrated in FIG. 4 is provided by way of example only, and any suitable machine system including metallic components for which data is to be stored and accessed may be envisaged.

Certain of the mechanical components of the system 44 may be of sufficient importance to make storing and accessing detailed information regarding the components of particular interest. That is, components such as motors, bearings, pulleys, pumps, valving, and so forth, may be expensive, difficult to access, and may require servicing from time to time. Such metallic mechanical components are associated with the RFID tagging device of the present invention, as illustrated generally at reference numeral 58 in FIG. 4. The devices, mounted on their respective mechanical components, will store at least identification information for the components. As will be appreciated by those skilled in the art, passive RFID tagging devices may store such information in accordance with several different standards. For example, electronic product codes (EPCs) have been standardized that can store some 96 bits of information divided into fields in accordance with established standards. This identification information can be accessed by a reader unit 60 which, in the illustrated embodiment is a hand-held transmitted/receiver that can be approached to the devices to read their particular identification data. In certain embodiments, the reader 60 may accommodate adjustment of its range as to more easily distinguish between detected devices. Ranges of anywhere from 6 inches to 12 feet are presently contemplated. In other arrangements, however, fixed wireless readers may be incorporated into the system.

In practice, service personnel or technicians gathering information for the tagged mechanical components will transmit a signal from the reader to the components, which each return their unique identifying code. The information may then be communicated to a remote data system 62 which may be local to the reader 60, or completely remote from the reader. The data may be transmitted to the system 62 by any suitable network connection, wirelessly or wired, and in accordance with any suitable protocol.

The remote data 62 will typically include a communication circuit 64 which is capable of transmitting and receiving signals with the reader 60. The signals are decoded in accordance with the protocol and information is sent to a processor 66 which parses this data for the identification of one or more components of the machine system of interest. In the illustrated embodiment, the processor 66 is associated with a database 68 which stores cross-referenced information for the components. Such information may include, for example, the identification of the component, its location in the field, its manufacturing history, its service history, and so forth. As also illustrated in FIG. 4, a much more detailed and elaborated information for each component, generally represented by the product data 70, may be stored in memory and accessed by the processor 66 based upon the identification information stored in the RFID tagging devices. Such product data may include catalog data, links to maintenance instructions, installation instructions, and so forth. The product data may also include information relating to upgrades or service parts for individual components that may be necessary from time to time. Finally, in the illustrated embodiment, an interface circuit 72 permits interfacing with the processor 66 to access both the identification information and any associated information stored in the database 68 or the product data 70. As in conventional computer systems, the interface circuit 72 will permit interfacing with an operator workstation 74. The remote data system 62 and the operator workstation 74 may comprise application specific computers, general purpose computers, programmable logic controllers, human interface modules, and so forth.

As will be appreciated by those skilled in the art, the RFID tagging devices of the present invention, and particularly in association with sophisticated reading and data storage systems greatly aids in the maintenance and support functions of factory personnel. They, in general, permit data to be readily accessed for mechanical components that was simply inaccessible before the invention. It is presently contemplated that components may be either retrofitted with the tagging devices, such as by using an available fastener aperture, such as a threaded hole, or dedicated tags may be shipped with mechanical components upon their original purchase and installation. In the latter case, databases can be established for entire machine systems at the time of its assembly and installation. Thereafter, data can be accessed by service personnel without the need to store the information on the individual components themselves.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A radio frequency (RF) tagging device for a metallic mechanical component comprising:
a non-metallic support having an aperture formed therethrough for receiving a fastener to secure the tag to the mechanical component; and
an RF tag supported on the support and encoding at least identification information for the mechanical component to which the device is secured.

2. The device of claim 1, wherein the support includes a generally toroidal body made of a synthetic plastic material.

3. The device of claim 1, wherein the RF tag is adhesively applied to the support.

4. The device of claim 1, wherein the RF tag is embedded in the support.

5. The device of claim 1, wherein the RF tag is a passive tag that provides a unique identification code when excited by a reader.

6. The device of claim 1, wherein the RF tag is generally rectangular in shape, and the support is a toroidal disk, whereby the RF tag is wrapped around the disk for isolation from the mechanical component and from the fastener.

7. The device of claim 6, wherein the RF tag is approximately 4 inches in length and the disk is approximately between 1 and 2 inches in diameter.

8. The device of claim 1, wherein the RF tag returns a signal to a reader when excited at a frequency of 13.56 MHz, 915 MHz, or 2.4 GHz.

9. The device of claim 1, wherein the support spaces the tag at least approximately ⅛ inch from surrounding metal when the device is placed in service.

10. A radio frequency (RF) tagging device for a mechanical component comprising:
a toroidal support made of a synthetic plastic material and having an aperture formed therethrough for receiving a fastener to secure the tag to the mechanical component; and
an RF tag wrapped around and adhesively affixed to the support and encoding at least identification information for the mechanical component to which the device is secured.

11. The device of claim 10, wherein the RF tag is a passive tag that provides a unique identification code when excited by a reader.

12. The device of claim 10, wherein the RF tag is approximately 4 inches in length and the disk is approximately 1 to 2 inches in diameter.

13. The device of claim 10, wherein the RF tag returns a signal to a reader when excited at a frequency of 13.56 MHz, 915 MHz, or 2.4 GHz.

14. The device of claim 10, wherein the support spaces the tag at least approximately ⅛ inch from surrounding metal when the device is placed in service.

15. A radio frequency (RF) tagging kit for a mechanical component comprising:
a toroidal support made of a synthetic plastic material and having an aperture formed therethrough and a peripheral surface for receiving an RF tag;
a passive RF tag wrapped around and adhered to the peripheral surface, the tag encoding at least identification information; and
a fastener configured to be fitted through the aperture in the support and to be secured to a metallic mechanical component.

16. The device of claim 15, wherein support includes pair of lips adjacent to the peripheral surface for protecting the tag during use.

17. The device of claim 15, wherein the RF tag is approximately 4 inches in length and the disk is approximately 1 to 2 inches in diameter.

18. The device of claim 15, wherein the RF tag returns a signal to a reader when excited at a frequency of 13.56 MHz, 915 MHz, or 2.4 GHz.

19. The device of claim 15, wherein the support spaces the tag at least approximately ⅛ inch from surrounding metal when the device is placed in service.

20. The device of claim 15, wherein the fastener is a threaded fastener configured to be screwed into a mating threaded opening in the component.
